(19) United States
(12) Patent Application Publication
(10) Pub. No.: US 2010/0308293 A1
(43) Pub. Date: Dec. 9, 2010

(54) RAILING SYSTEM

(76) Inventors: Fred Larkins, Mill Creek, WA (US); Francis Church, Tacoma, WA (US)

Correspondence Address: BLACK LOWE & GRAHAM, PLLC, 701 FIFTH AVENUE, SUITE 4800, SEATTLE, WA, 98104, US

(21) Appl. No.: 12/793,322

(22) Filed: Jun. 3, 2010

Related U.S. Application Data
(60) Provisional application No. 61/183,745, filed on Jun. 3, 2009.

(51) Int. Cl. E04H 17/14; B23P 11/00

(52) U.S. Cl. 256/65.09; 256/65.02; 256/65.11; 29/525.02

(57) ABSTRACT

A railing system, and more specifically a modular, stainless steel railing system, includes posts that secure to a mounting surface, rails that extend between the posts, coupling members for attaching the rails to the posts, and optionally a rail cap. In one embodiment, the coupling members may take the form of a dowel or pin having an externally threaded portion that is threadably connected to the posts and another portion, either threaded or non-threaded, that is slidably received into the rails. In another embodiment, the coupling members may take the form of sleeves inserted into the rails and mechanically attached thereto. Once attached to the rails, the sleeves are engaged by fasteners that extend through the post and operate to urge the rail and the post into close contact.

### PRIORITY CLAIM

This application claims priority to co-pending, commonly owned U.S. Provisional Patent Application No. 61/183,745 (filed on Jun. 3, 2009), and wherein the subject matter of this provisional patent application is incorporated herein by reference in its entirety.

### FIELD OF THE INVENTION

This invention relates generally to a railing system, and more specifically to a modular, metallic railing system having non-welded connections.

### BACKGROUND OF THE INVENTION

Metal railing systems, but more especially stainless steel railing systems, typically require the primary components (e.g., posts, rails, balusters and caps) to be welded together to form the required shapes, achieve the desired design, and provide the necessary structural load paths. To install a stainless steel railing on-site, the installation crew generally needs a portable welder and must go through time consuming steps to place safety barriers around the installation area. Once the welds are complete they must be polished to achieve a finished look. On modular metal railing systems, which do exist, the connections are complicated, unsuitable or overly difficult for consumer installation, or non-aesthetically pleasing, which limits these systems to factory assembly and bulk installation on-site—the latter being problematic if adjustments are required. Alternatively, existing modular metal railing systems may be assembled and installed on-site by experienced crews, but even then the installation process is time consuming and costly. One example of a non-welded, yet complicated railing system is the SUNRAIL™ custom stainless steel rail system made by Suncor Stainless, Inc. (http://www.suncorstainless.com/railing.html).

In addition, many building authorities or codes have strict guidelines for vertical spacing of spindles or similar components or horizontal spacing of rails to prevent small children from falling through the gaps. Thus, non-metal type railing systems (e.g., vinyl) and aluminum railing systems may not be structurally robust enough for some applications and must either be welded together at the joints or require special joint connectors. Cable-type railings, which are fairly popular, have been known to become slack over time, which often requires periodic inspections, maintenance visits and possibly replacement activities.

### SUMMARY OF THE INVENTION

This invention generally relates, but is not limited, to a railing system and at least one method of assembling and/or installing the same, and more specifically the present invention relates to a modular, metallic railing system that is customizable, less expensive than many existing systems, requires less time to assembly and install, and meets local building codes. The railing system includes posts that secure to a mounting surface, rails that extend between the posts, coupling members for attaching the rails to the posts, and optionally a rail cap. In one embodiment, the coupling members are threadably connected to the posts and slidably received into the rails. In this embodiment, the coupling members may take the form of a dowel or pin having an externally threaded portion. In another embodiment, the coupling members are sleeves inserted into the rails and mechanically attached thereto. Once attached to the rails, the sleeves are engaged by fasteners that extend through the post and operate to urge the rail and the post into close contact.

In one aspect of the invention, a rail system includes an end post attachable to a surface; an intermediate post separated from the end post by a desired distance, the intermediate post attachable to the surface; a railing member extending between the end post and the intermediate post; and a coupling member configured to non-weldably attach the railing member to the end post.

In another aspect of the invention, a rail system includes a first post attachable to a surface, the first post having a post opening defined by an internally threaded wall; a second post positionable from the first post by a desired distance, the second post attachable to the surface; a railing member extending from the first post to at least the second post, the railing member having an outer perimeter surface and an inner perimeter surface that defines a railing member opening; and a dowel pin having a first portion and a second portion, the first portion externally threaded to threadably engage the internally threaded wall of the first post, the second portion sized for slideable insertion into the railing member opening.

In yet another aspect of the invention, a rail system includes a first post attachable to a surface, the first post having a pass-through post opening; a second post positionable from the first post by a desired distance, the second post attachable to the surface; a railing member extending from the first post to at least the second post, the railing member having an outer perimeter surface and an inner perimeter surface that defines a railing member opening; a sleeve closely receivable in the railing member opening and mechanically attachable thereto, the sleeve having an internally threaded surface; and a fastener extending through the pass-through post opening and threadably engageable with the internally threaded surface of the sleeve, wherein rotation of the fastener in a desired direction secures the railing member to the first post.

In still yet another aspect of the invention, a method for installing a railing system includes the steps of (1) positioning a first post relative to a mounting surface; (2) positioning a second post relative to the mounting surface; (3) inserting a threaded member into the first post; and (4) threadably attaching a railing member to the first post with the threaded member.

### BRIEF DESCRIPTION OF THE DRAWINGS

Preferred and alternative embodiments of the present invention are described in detail below with reference to the following drawings.

FIG. 1 is a perspective view of a railing system according to an embodiment of the present invention;

FIG. 2 is a perspective view of another railing system having balusters according to another embodiment of the present invention;

FIG. 3 is a partial side-elevational view of an end post of the railing system of FIG. 1 having a plurality of threaded openings according to an embodiment of the present invention;

FIG. 4 is a partial front-elevational view of the end post of the railing of FIG. 1 with coupling members being inserted into the threaded openings of FIG. 3 according to an embodiment of the present invention;

FIG. 5 is a perspective view of the end post of FIG. 1 with coupling members installed therein according to an embodiment of the present invention;

FIG. 6 is a perspective view of an intermediate post of FIG. 1 with coupling members installed therein, the coupling members set to receive the railing members of FIG. 1 according to an embodiment of the present invention;

FIG. 7 is a front-elevational view of another railing system having a sleeve and fastener type assembly between the end post and rail members according to another embodiment of the present invention; and

FIG. 8 is a close-up, partial cross-sectional view of the railing member and a swaged sleeve located in the railing member, and where the sleeve is threadably attached to the post 202 according to an embodiment of the present invention.

### DETAILED DESCRIPTION OF THE PREFERRED EMBODIMENTS

The present invention is generally directed to a railing system and at least one method of assembling the same, and more specifically the present invention is directed to a modular, metallic railing system that is customizable, less expensive than many existing systems, requires less time to assembly and install, and meets local building codes. In one embodiment, at least some of the components of the railing system may be made from mild or stainless steel. The railing system includes posts that secure to a mounting surface, rails that extend between the posts, coupling members for attaching the rails to the posts, and optionally a rail cap. In one embodiment, the coupling members are threadably connected to the posts and slidably received into the rails. In another embodiment, the coupling members are sleeves inserted into the rails and mechanically attached thereto. In this embodiment, the sleeves are engaged by fasteners that extend through the post and operate to urge the rail and the post into close contact. In either embodiment, various types of seals or sealants may be provided to minimize and preferably prevent water ingression into the rails and posts.

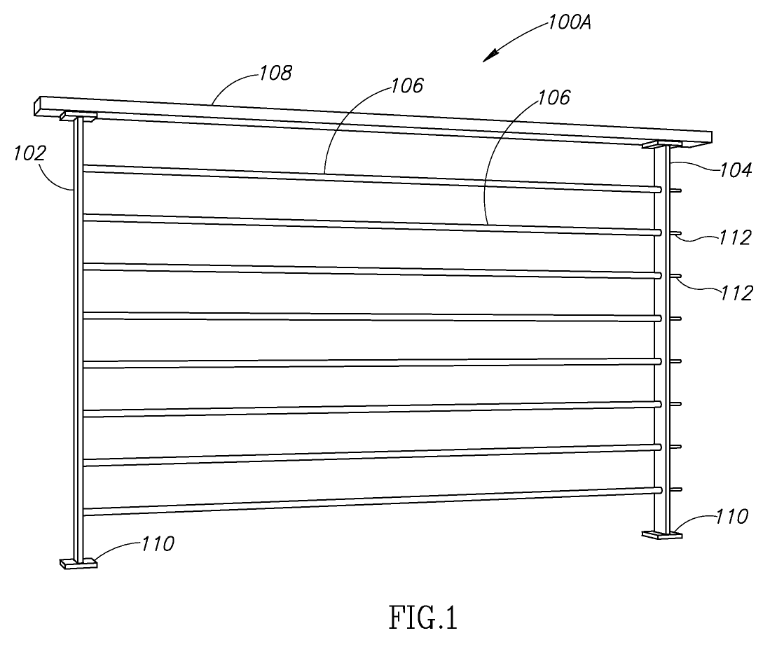

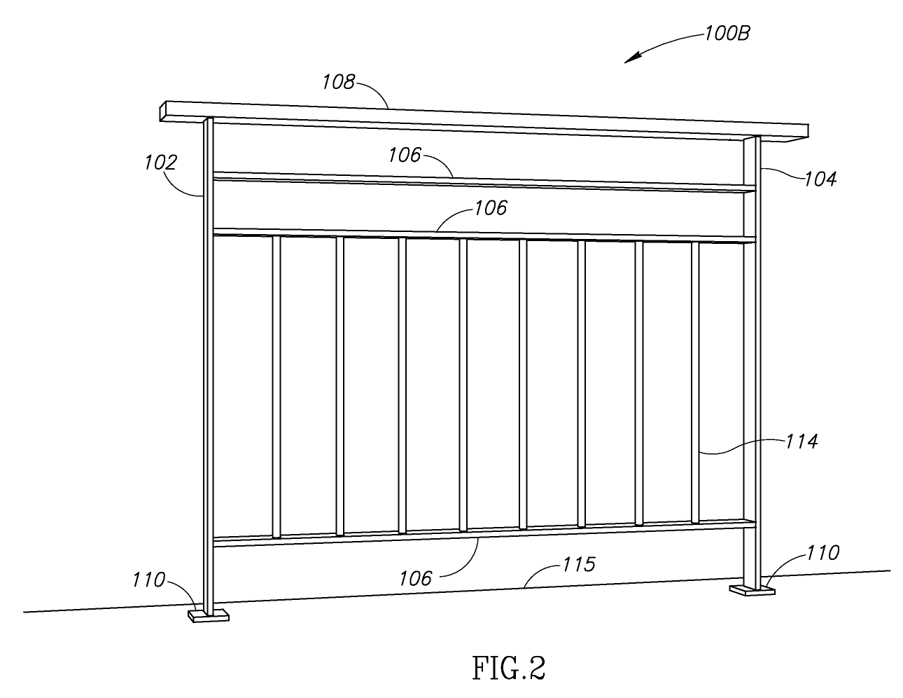

FIG. 1 shows a railing system 100A assembled in an exemplary configuration commonly referred to as a “Ty” style railing configuration. FIG. 2 shows another railing system 100B assembled in an exemplary configuration commonly referred to as a “Rone” style railing system. Both railing systems 100A and 100B are preferably stainless steel railing systems, however it is appreciated that some or all of the components may be made from a different metal or from some other material in which the assembly and installation techniques discussed herein may be employed. In one embodiment, the railing systems 100A and 100B may be powder coated to achieve a desired look and feel. Further, the configurations and dimensions of the railing systems 100A, 100B may be selected or customized to create railing systems that follow complex contours. Likewise, the components and techniques described herein may be used for railing systems other than the exemplary configurations shown in FIGS. 1 and 2.

The main components of both railing systems are essentially the same in terms of their structural purpose, method of assembly, and method of installation. Both railing systems 100A and 100B include an end post 102 separated by a desired distance from a second post 104, which may take the form of another end post, an intermediate post, or an intermediate pass-through post, and each option will be described in more detail below. Extending between the posts 102, 104 are railing members 106, which may have a desired type of cross-sectional shape, such as, but not limited to, tubular or square.

The railing systems 100A and 100B may each include a rail cap 108, which is attached to at least the end post 102. In the illustrated embodiment, the rail cap 108 is attached to structural bosses 110 that are either coupled to or integrally formed with the posts 102, 104. The bosses 110 may take the form of plates having openings to receive fasteners (not shown), which in turn may be used to attach the posts 102, 104 to a mounting surface 115. It is appreciated that the bosses 110 may take a variety of forms and be attachable to a variety of surfaces, to include vertical or angled mounting surfaces. In addition, it is appreciated that the rail cap 108 may be coupled to the end post 102 by other means known in the railing industry.

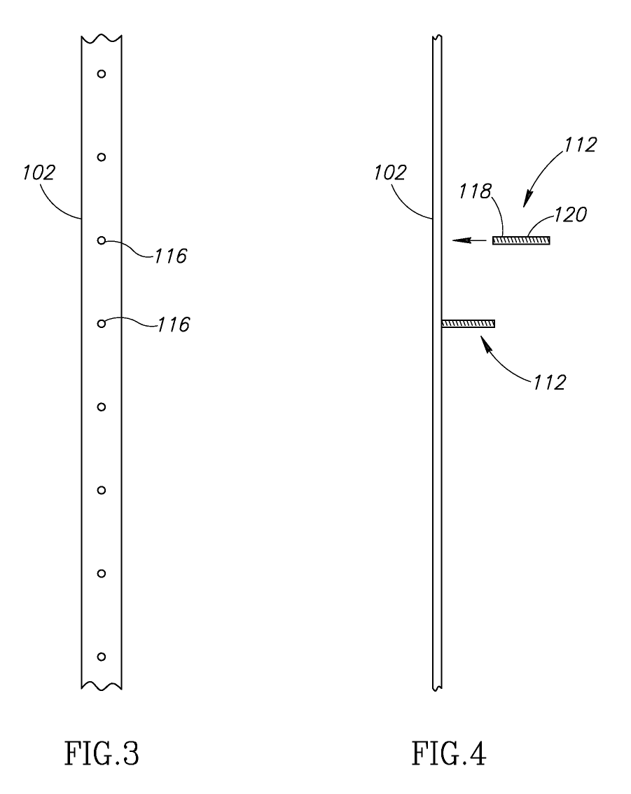

Now specifically referring to the railing system 100A of FIG. 1, coupling members 112 are threaded into the end post 102 and the intermediate post 104. The structural configurations, purpose and installation of the coupling members 112 will be explained in more detail below with respect to FIGS. 3-6.

Now specifically referring to the railing system 100B of FIG. 2, this railing system includes balusters 114 that extend between railing members 106. The balusters 114 may come pre-assembled with the railing members 106 or may be installed on-site. In the latter scenario, the balusters are assembled with the railing members and then this sub-assembly is attached to the posts 102, 104.

FIG. 3 shows the end post 102 having a plurality of internally threaded openings 116 arranged along a height of the end post 102. In the illustrated embodiment, each opening 116 corresponds to the respective location of each railing member 106 of railing system 100A. In the illustrated example, the eight openings shown in FIG. 3 correspond to the eight railing members 106 shown in FIG. 1. The openings 116 may be drilled and tapped to threadably receive the coupling members 112 as best shown in FIG. 4. The coupling members 112 may take the form of a dowel, pin or rod having a threaded end-post portion 118 and a railing member receiving portion 120, which may be threaded or non-threaded. In the illustrated embodiment, both portions 118, 120 have external threads and may take the form of “all thread” rod. All thread rods are commonly used for general purpose fastening, are generally inexpensive compared with headed bolts or fasteners, and their length may be easily modified on a job site. The coupling member 112 may be obtained in variety of grades and materials, such as, but not limited to stainless steel.

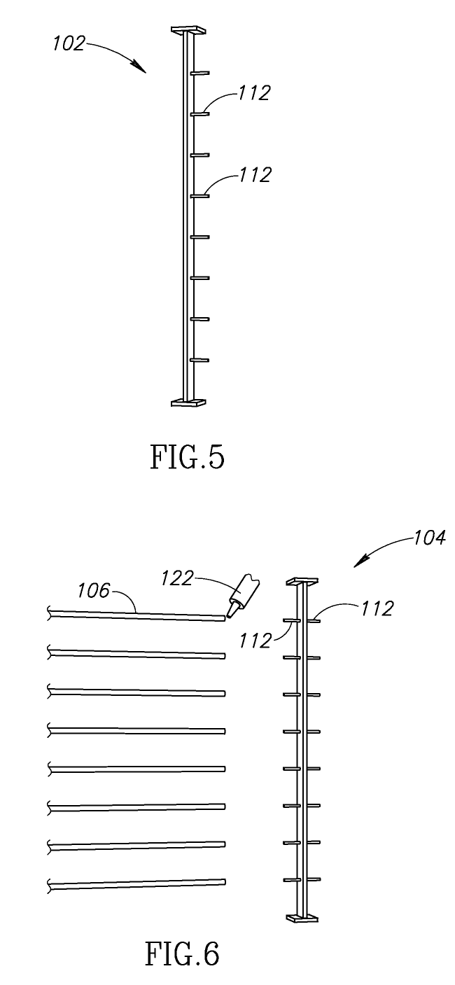

FIGS. 5 and 6 show the assembly of the railing members 106 with the end post 102 for the railing system 100A. In FIG. 5, the coupling members 112 are threaded into openings 116 (FIG. 3) of the end post 102 while additional coupling members 112 are threaded into corresponding openings of the intermediate member 104 (FIG. 6). Before securing the end post 102 and the intermediate post 104 to the mounting surface, the railing members 106 are slideably received onto the coupling members 112. Stated alternatively, the coupling members 112 are inserted into the railing members 106. To help prevent moisture ingression into the railing members 106 and the openings formed in the posts 102, 104, a sealant 122 (schematically illustrated in FIG. 6) may be applied onto the coupling members 106, into the openings in the posts 102, 104 and into the openings in the rail members 106, respectively. In one embodiment, the coupling members 112 may be taped or wrapped with a malleable material, such as pipe thread. Once assembled and installed into a building or elsewhere, the modular railing system may have the appearance of a welded railing system and yet require a fraction of the time to assemble and install.

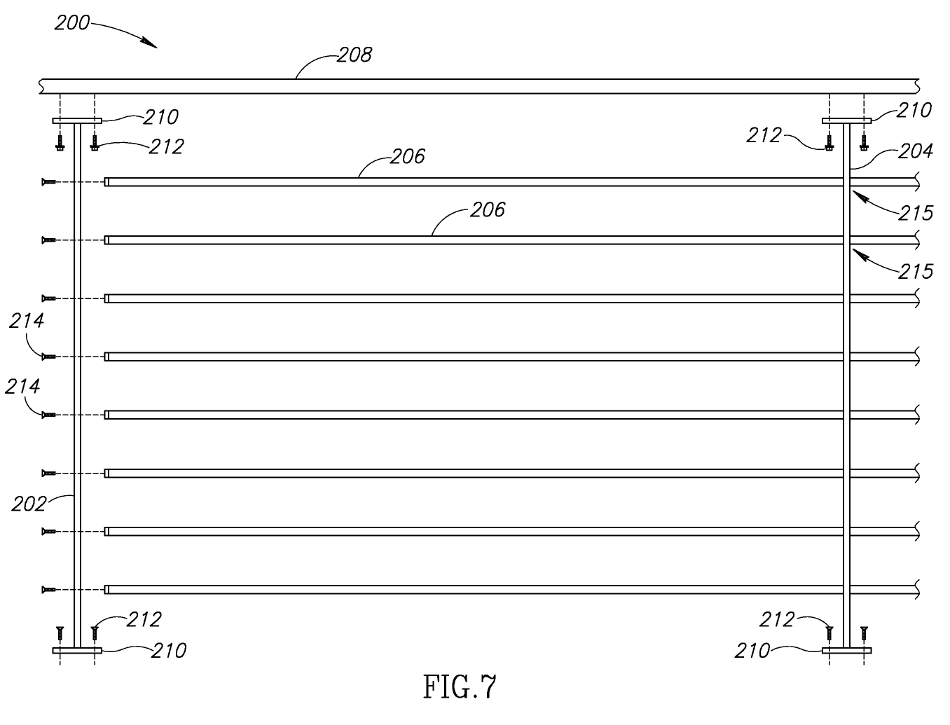

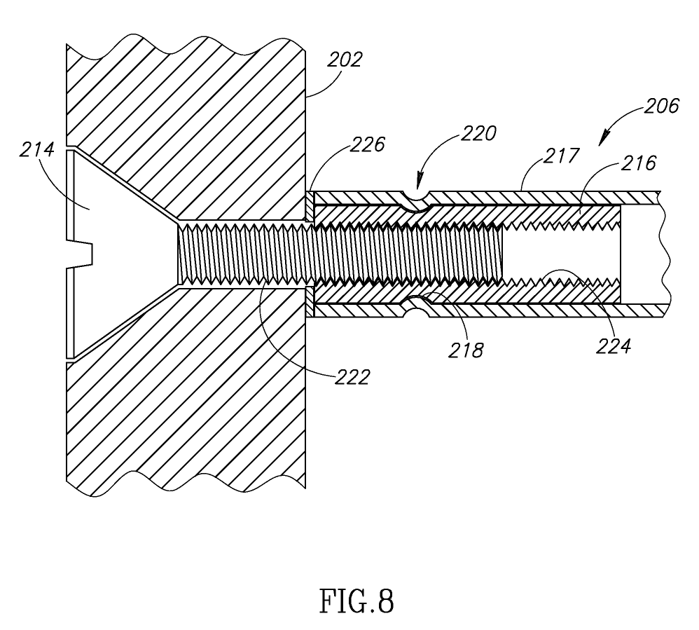

FIGS. 7 and 8 show a railing system 200 having an end post 202, an intermediate, pass-through post 204 and rail assemblies 206. A railing cap 208 is attached to the posts 202, 204 in the illustrated embodiment. The posts include bosses 210 for attaching the railing system 200 to a mounting surface (not shown). In the illustrated embodiment, first fasteners 212 may be used to attach the railing cap 208 to the posts 202, 204 and to attach the posts to the mounting surface. Second fasteners 214 are placed into the end post 202 and threadably engage the rail assemblies 206.

The intermediate, pass-through post 204 includes openings 215 that are selectively arranged to receive the rail assemblies 206 and permit them to pass through the intermediate post 204. Thus, the rail assemblies 206 are not attached or coupled to the intermediate post 204, but simply pass through and may or may not be in supporting contact with the intermediate post depending on the amount of tension, distance between posts, and other design or installation factors.

Now referring specifically to FIG. 8, the rail assembly 206 includes a sleeve 216 received into a rail member 217, which includes at least a hollow end portion for receiving the sleeve. The rail member 217 is mechanically coupled to the sleeve 216, and is preferably coupled to the sleeve by a swaging process or crimping, but may be coupled by other means such as, but not limited, bonding, press fit, thermal fit, threaded connection, etc. In the illustrated embodiment, the sleeve is coupled to the rail member 217 with a swaging process that generates a swaged section 218 in the sleeve 216 and also generates a recessed or dimpled section 220 in the rail member 217. The location of the swaged section 218 may be varied, but generally should not be too close to the end of the rail member 217.

During assembly and/or installation of the railing system 200 and after the end post 202 is set, the rail assemblies 206 may be connected to the end post 202 with the fasteners 214, which may take the form of flush head fasteners. External threads 222 of the fasteners 214 engage internal threads 224 of the sleeve 216 to urge the rail assembly 206 into tight contact with the end post 202. In one embodiment, a seal, washer, sealant or some combination thereof (to include multiple seals or washers) may be positioned between the rail assembly 206 and the end post 202 before the fastener 214 is tightened.

While the preferred embodiments of the invention have been illustrated and described, as noted above, many changes can be made without departing from the spirit and scope of the invention. Accordingly, the scope of the invention is not limited by the disclosure of the preferred embodiments. Instead, the invention should be determined entirely by reference to the claims that follow.

1. A rail system comprising:
an end post attachable to a surface;
an intermediate post separated from the end post by a desired distance, the intermediate post attachable to the surface;
a railing member extending between the end post and the intermediate post; and
a coupling member configured to non-weldably attach the railing member to the end post.

2. The rail system of claim 1, wherein the intermediate post is another end post.

3. The rail system of claim 1, wherein the surface is a vertical surface.

4. The rail system of claim 1, wherein the intermediate post is a pass-through post having an opening sized to permit the railing member to pass through the opening.

5. The rail system of claim 1, wherein the coupling member includes an internally threaded sleeve fixed into the railing member.

6. The rail system of claim 5, further comprising a threaded fastener having a head portion and a threaded body portion, the head portion engageable with a surface of the end post and sized to prevent the head portion from moving through an opening in the end post, the body portion extending through the opening threadably engage the sleeve.

7. The rail system of claim 5, wherein the sleeve is coupled to the railing member by way of a swaging process.

8. The rail system of claim 1, wherein the coupling member includes a dowel having a threaded portion and a railing engagement portion, the threaded portion receivable by an internally threaded opening formed in the end post and the railing engagement portion slideably receivable into the railing member.

9. The rail system of claim 1, further comprising a railing cap coupled to the end post.

10. A rail system comprising:
a first post attachable to a surface, the first post having a post opening defined by an internally threaded wall;
a second post positionable from the first post by a desired distance, the second post attachable to the surface;
a railing member extending from the first post to at least the second post, the railing member having an outer perimeter surface and an inner perimeter surface that defines a railing member opening; and
a dowel pin having a first portion and a second portion, the first portion externally threaded to threadably engage the internally threaded wall of the first post, the second portion sized for slideable insertion into the railing member opening.

11. The rail system of claim 10, wherein the first post is an end post and the second post is an intermediate, pass-through post having an opening sized to allow the railing member to pass-through the opening.

12. The rail system of claim 10, wherein the surface is a vertical surface.

13. The rail system of claim 10, wherein the railing member is oriented substantially orthogonal to the first post.

14. The rail system of claim 10, wherein the railing member is cylindrical such that the outer perimeter surface and the inner perimeter surface define a cylindrical wall.

15. The rail system of claim 10, wherein the second portion of the dowel pin is externally threaded.

16. A rail system comprising:
a first post attachable to a surface, the first post having a pass-through post opening;
a second post positionable from the first post by a desired distance, the second post attachable to the surface;
a railing member extending from the first post to at least the second post, the railing member having an outer perimeter surface and an inner perimeter surface that defines a railing member opening;
a sleeve closely receivable in the railing member opening and mechanically attachable thereto, the sleeve having an internally threaded surface; and
a fastener extending through the pass-through post opening and threadably engageable with the internally threaded surface of the sleeve, wherein rotation of the fastener in a desired direction secures the railing member to the first post.

17. The rail system of claim 16, wherein the sleeve being mechanically attachable to the railing member includes the sleeve being swaged with the railing member.

18. The rail system of claim 16, wherein the past-through post opening includes a countersunk portion to receive a flush head of the fastener.

19. The rail system of claim 16, further comprising a sealant applicable between the railing member and the first post to substantially prevent moisture ingression into the railing member.

20. The rail system of claim 16, further comprising a rail cap attachable to at least the first post.

21. A method for installing a railing system, the method comprising:
positioning a first post relative to a mounting surface;
positioning a second post relative to the mounting surface;
inserting a threaded member into the first post; and
threadably attaching a railing member to the first post with the threaded member.

22. The method of claim 21, wherein inserting the threaded member into the first post includes inserting a fastener in an opening of the first post, the fastener having a head portion in contact with a surface of the first post and having a threaded body portion engaged with an internally threaded sleeve received into an end portion of the railing member.

23. The method of claim 21, wherein inserting the threaded member into the first post includes threading a dowel pin into an internally threaded opening formed in the first post.

24. The method of claim 23, wherein threadably attaching the railing member includes sliding the railing member onto the dowel pin after the dowel pin is threadably engaged with the first post.

25. The method of claim 21, further comprising attaching the first and second posts to the mounting surface.
